(19) United States
(12) Patent Application Publication
(10) Pub. No.: US 2022/0092469 A1
(43) Pub. Date: Mar. 24, 2022

(54) MACHINE LEARNING MODEL TRAINING FROM MANUAL DECISIONS

(71) Applicant: International Business Machines Corporation, Armonk, NY (US)

(72) Inventors: Lars Bremer, Boeblingen (DE); Hemanth Kumar Babu, Boblingen (DE); Thuany Karoline Stuart, Aachen (BR); Martin Oberhofer, Sindelfingen (DE)

(21) Appl. No.: 17/029,212

(22) Filed: Sep. 23, 2020

(51) Int. Cl. G06N 20/00; G06N 7/00

(52) U.S. Cl. CPC G06N 20/00; G06N 7/005

(57) ABSTRACT

In an approach to improving machine learning model training for data matching from manual decisions, one or more computer processors detect a correction made to two data records. One or more computer processors determine a common attribute between the two data records. One or more computer processors identify a first machine learning model associated with the common attribute. One or more computer processors add comparison data of the two data records to training data for the machine learning model, where the comparison data includes the correction.

### BACKGROUND OF THE INVENTION

The present invention relates generally to the field of master data management, and more particularly to improving machine learning model training for data matching from manual decisions.

Master data refers to classes of information such as products or suppliers that are common to a number of computer systems and applications within a company. The different computer systems can belong to the same company or can belong to different companies, such as vendors or contractors. The master data can be stored in a number of different locations, computer systems, and/or incompatible formats. Master data management (MDM) is a top priority for many organizations as they aim to deliver and leverage trusted business information. Master data is high value information such as customer, supplier, partner, product, materials, and employee data. Master data is critical for addressing business problems and is important for a plurality of business transactions, applications, and decisions. An effective MDM strategy can assist organizations in responding quickly and easily to existing and changing business needs. MDM software is used to make sure master data entities are kept consistent and accurate.

MDM relies on clean, duplicate-free data to be an effective business tool. Matching plays an important role in achieving a single view of customers, parts, transactions, and almost any type of data. Matching is the process of putting together similar or identical data records in order to either identify or remove duplicates from the data. Matching is often used to link together data records that have some sort of relationship. The strength of matching technology is defined by how powerful the algorithms are to establish the match. There are two common types of matching technology on the market today: deterministic and probabilistic. Deterministic matching is rules-based, where data records are compared using fuzzy algorithms. Probabilistic matching technology performs statistical analysis on the data, and then uses that analysis to weight the match.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. Machine learning explores the study and construction of algorithms that can learn from and make predictions based on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data.

Predicting whether two persons in an MDM reference are the same physical person is a difficult problem. Machine learning has proven to be superior to deterministic and probabilistic matching systems that are complex and therefore difficult and time consuming to configure correctly. Using specialized machine learning models for different attributes (e.g., name, date of birth) of the comparison is beneficial to reduce complexity of the problem. Machine learning models can be pre-trained with synthetic data that work reasonably well, but currently if user feedback is collected, the feedback considers the entire record similarity and not attribute similarity. The user feedback may not enable determining how well the individual machine learning models are working. As a result, valuable user feedback is not used to improve the models.

### SUMMARY

Embodiments of the present invention disclose a method, a computer program product, and a system for improving machine learning model training for data matching from manual decisions. The method may include one or more computer processors detecting a correction made to two data records. One or more computer processors determine a common attribute between the two data records. One or more computer processors identify a first machine learning model associated with the common attribute. One or more computer processors add comparison data of the two data records to training data for the machine learning model, where the comparison data includes the correction.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a model training program, on a server computer within the distributed data processing environment of FIG. 1, for improving training of machine learning models for data matching by capturing manual decisions, in accordance with an embodiment of the present invention;

FIG. 3A illustrates an example of operational steps of the model training program, on the server computer within the distributed data processing environment of FIG. 1, in accordance with an embodiment of the present invention;

FIG. 3B illustrates an example of operational steps of the model training program, on the server computer within the distributed data processing environment of FIG. 1, in accordance with an embodiment of the present invention; and

FIG. 4 depicts a block diagram of components of the server computer executing the model training program within the distributed data processing environment of FIG. 1, in accordance with an embodiment of the present invention.

### DETAILED DESCRIPTION

Embodiments of the present invention recognize that improvements can be made in the training of machine learning models for data matching by capturing manual linkage or unlinks of data records subsequent to the models' matching decision. Embodiments of the present invention identify training data for machine learning models and improve attribute-specific machine learning classifiers that are part of a matching algorithm. Embodiments of the present invention also recognize that efficiency may be gained by capturing user feedback on the level of individual attributes associated with individual machine learning models with no need for the user to explicitly provide the feedback. Implementation of embodiments of the invention may take a variety of forms, and exemplary implementation details are discussed subsequently with reference to the Figures.

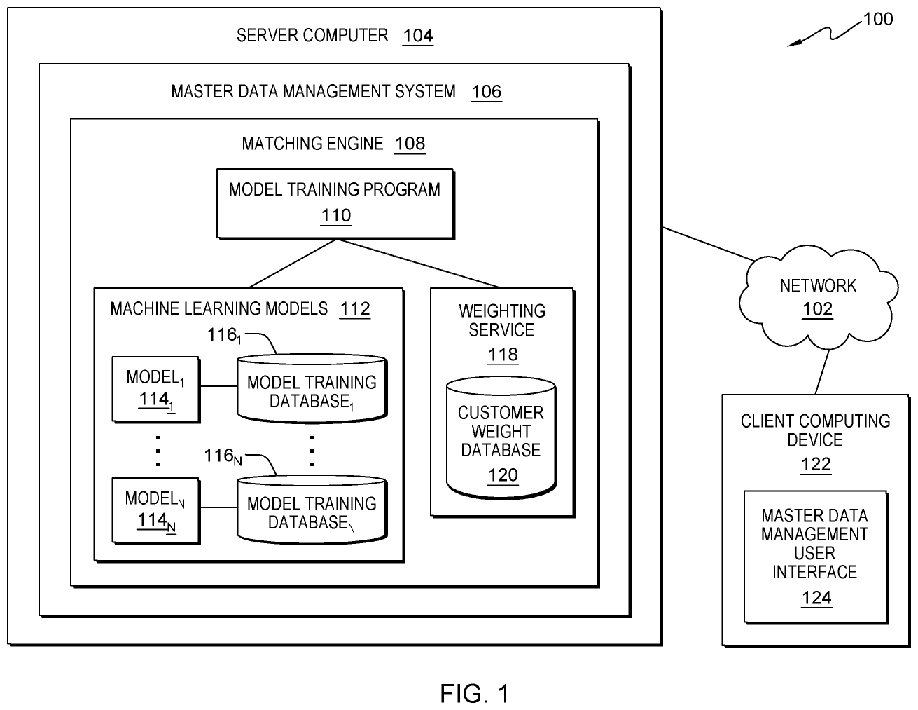

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 122, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 122, and other computing devices (not shown) within distributed data processing environment 100.

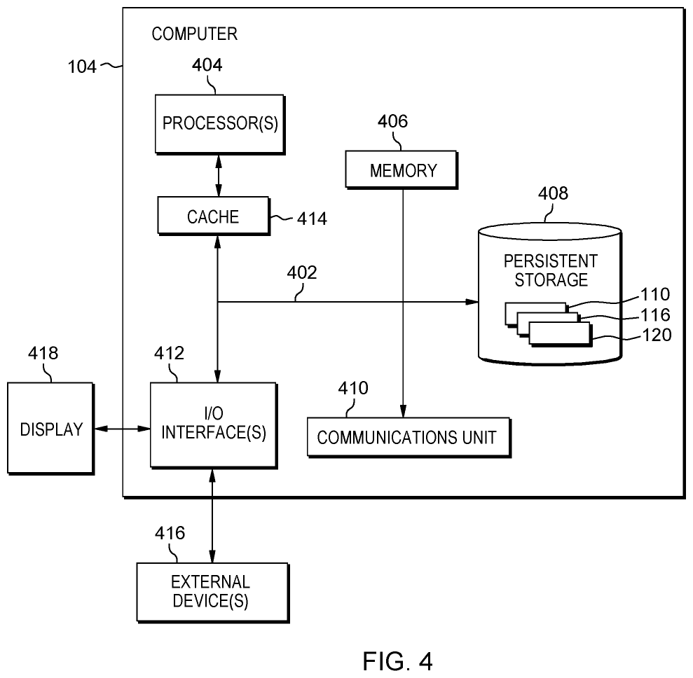

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 122 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes master data management system 106, matching engine 108, model training program 110, machine learning models 112, model 114_{1-N}, model training database 116_{1-N}, weighting service 118, and customer weight database 120. Server computer 104 may include internal and external hardware components, as depicted and described in further detail with respect to FIG. 4.

Master data management (MDM) system 106 is one or more of a plurality of software tools that can be used to support master data management by removing duplicates, standardizing data (mass maintaining), and incorporating rules to eliminate incorrect data from entering the system in order to create an authoritative source of master data. MDM system 106 includes matching engine 108.

Matching engine 108 is one or more of a plurality of software tools used for a variety of functions including matching data records between multiple databases and detecting duplicate data records. Matching engine 108 may also be responsible for linking or unlinking data records for matching purposes. Matching engine 108 may also receive and executes requests from users to link or unlink previously matched data records. In an embodiment, matching engine 108 uses multiple machine learning classifiers that are each specialized to predict how similar a certain attribute is to another attribute. Matching engine 108 weights the predictions according to a matching configuration. Matching engine 108 combines the weighted predictions to create a similarity score which is an indicator of how similar two records are to each other. Matching engine 108 uses the similarity score to automatically process potential duplicates. Matching engine 108 includes model training program 110, machine learning models 112, and weighting service 118.

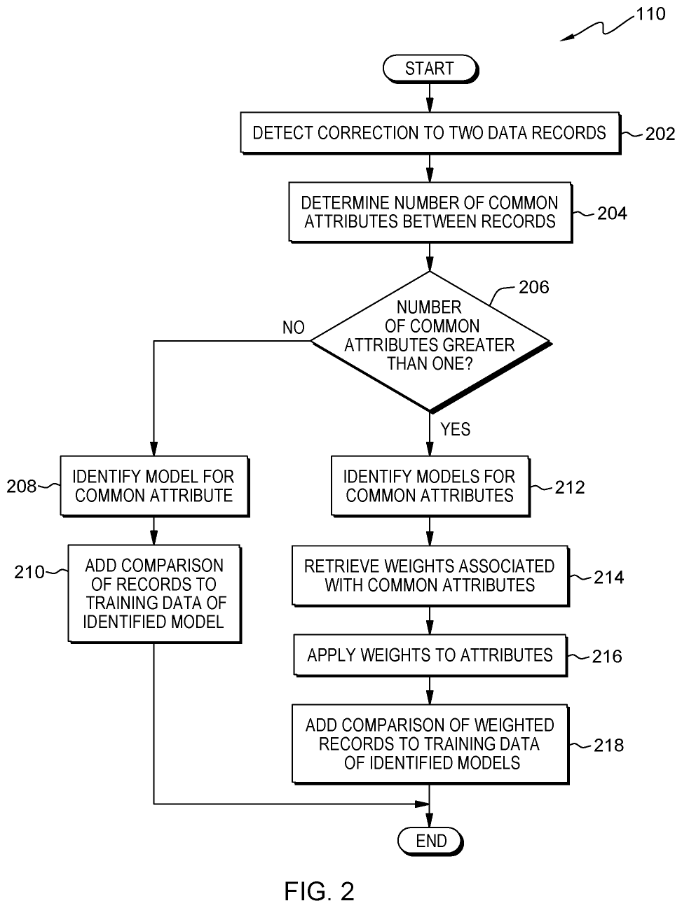

Model training program 110 improves attribute-specific machine learning classifiers that are part of a matching algorithm by capturing user feedback and adding the labelled feedback to the training data. Adding user feedback to machine learning training data is advantageous because it adds real life data to synthetic data and improves the performance of the matching engine. Model training program 110 detects a correction to two data records. Model training program 110 determines the number of common attributes between the two data records. If model training program 110 determines the two data records have one common attribute, then model training program 110 identifies which of machine learning models 112 is associated with the common attribute and adds the comparison of the two data records to the training data of the identified model. If model training program 110 determines that the two data records have more than one attribute in common, then model training program 110 identifies which of machine learning models 112 is associated with the common attributes. Model training program 110 retrieves weights associated with the common attributes and applies the weights. Model training program 110 adds the comparison of the weighted data records to the training data of the identified models. Model training program 110 is depicted and described in further detail with respect to FIG. 2.

Machine learning models 112 is a collection of individual models 114_{1-N}, herein model(s) 114, where each of model(s) 114 is an attribute-specific model for attribute-specific machine learning classifiers that are part of a matching algorithm. For example, model 114₁ may be for names, model 114₂ may be for addresses, and model 114₃ may be for birthdates. Each of model(s) 114 predicts how similar the compared attribute is to another attribute. In addition, machine learning models 112 includes a database associated with each model, i.e., model training database 116_{1-N}, herein model training database(s) 116, where, for example, model training database 116₁ stores the training data for model 114₁, and model training database 116_{N} stores the training data for model 114_{N}. As used herein, N represents a positive integer, and accordingly a number of scenarios implemented in a given embodiment of the present invention is not limited to those depicted in FIG. 1.

Weighting service 118 is one or more of a plurality of software tools that enable a user, such as a data engineer, to define or specify weight configurations for data record matching. Weighting service 118 includes customer weight database 120.

Model training database(s) 116 and customer weight database 120 are each a repository for data used by matching engine 108 and model training program 110. Model training database(s) 116 and customer weight database 120 can each represent one or more databases. In the depicted embodiment, model training database(s) 116 and customer weight database 120 reside on server computer 104. In another embodiment, model training database(s) 116 and customer weight database 120 may each reside elsewhere within distributed data processing environment 100, provided matching engine 108 and model training program 110 have access to model training database(s) 116 and customer weight database 120. A database is an organized collection of data. Model training database(s) 116 and customer weight database 120 can each be implemented with any type of storage device capable of storing data and configuration files that can be accessed and utilized by matching engine 108 and model training program 110, such as a database server, a hard disk drive, or a flash memory. Model training database(s) 116 store training data for model(s) 114. Customer weight database 120 stores customer-defined weights that matching engine 108 uses for attribute comparisons. The higher the weight, the higher the influence of the attribute on a matching decision. Model training program 110 uses the same weights to apply to classifiers to adjust the significance of the training data. Customer weight database 120 may also store data associated with customer profiles.

The present invention may contain various accessible data sources, such as model training database(s) 116 and customer weight database 120, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Model training program 110 enables the authorized and secure processing of personal data. Model training program 110 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Model training program 110 provides information regarding personal data and the nature (e.g., type, scope, purpose, duration, etc.) of the processing. Model training program 110 provides the user with copies of stored personal data. Model training program 110 allows the correction or completion of incorrect or incomplete personal data. Model training program 110 allows the immediate deletion of personal data.

Client computing device 122 can be one or more of a laptop computer, a tablet computer, a smart phone, smart watch, a smart speaker, or any programmable electronic device capable of communicating with various components and devices within distributed data processing environment 100, via network 102. Client computing device 122 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 122 may be integrated into a vehicle of the user. For example, client computing device 122 may include a heads-up display in the windshield of the vehicle. In general, client computing device 122 represents one or more programmable electronic devices or combination of programmable electronic devices capable of executing machine readable program instructions and communicating with other computing devices (not shown) within distributed data processing environment 100 via a network, such as network 102. Client computing device 122 includes an instance of master data management user interface 124.

Master data management (MDM) user interface 124 provides an interface between matching engine 108 on server computer 104 and a user of client computing device 122. In one embodiment, MDM user interface 124 is mobile application software. Mobile application software, or an “app,” is a computer program designed to run on smart phones, tablet computers and other mobile devices. In one embodiment, MDM user interface 124 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. MDM user interface 124 enables a user of client computing device 122 to interface with weighting service 118 to input preferred weighting of matching attributes for matching to be stored in customer weight database 120. MDM user interface 124 may also enable the user of client computing device 122 to input user profile information, such as name, account number, employer, etc.

FIG. 2 is a flowchart depicting operational steps of model training program 110, on server computer 104 within distributed data processing environment 100 of FIG. 1, for improving training of machine learning models 112 for data matching by capturing manual decisions, in accordance with an embodiment of the present invention.

Model training program 110 detects a correction to two data records (step 202). If matching engine 108 is perfect, then matching engine 108 automatically links together all records that reference the same physical person and unlinks records that reference different persons. However, since matching engine 108 cannot be perfect, a data steward manually links and unlinks records for which matching engine 108 made an incorrect decision. In an embodiment, model training program 110 detects the manual correction made by a data steward via MDM user interface 124 to either link two data records or unlink, i.e., separate, two data records.

Model training program 110 determines a number of common attributes between the two data records (step 204). In an embodiment, model training program 110 determines the information entropy between the two records, i.e., how much information model training program 110 can deduce from the records regarding how similar or how different the two records are from each other. In an embodiment, model training program 110 compares the two data records and determines how many attributes the records have in common. For example, if record A includes a name and a birthdate and record B includes a name and a social security number, then there is one common attribute, i.e., name. In another example, if record X includes a name, an address, and a social security number while record Y includes a name, an address, and a birthdate, then there are two common attributes, i.e., name and address.

Model training program 110 determines whether the number of common attributes is greater than one (decision block 206). In an embodiment, based on the comparison of the attributes in the two data records, model training program 110 determines whether the number of common attributes is one or greater than one.

If model training program 110 determines the number of common attributes is one (“no” branch, decision block 206), then model training program 110 identifies the model for the common attribute (step 208). In an embodiment, model training program 110 determines the two data records have one attribute in common, therefore there is one associated machine learning model, i.e., one of model(s) 114, for which the classifier is the common attribute. Continuing the example above, if record A includes a name and a birthdate and record B includes a name and a social security number, then the common attribute is name, and model training program 110 identifies the attribute-specific model for name. The identified model is responsible for not detecting the link/unlink performed by the data steward prior to the manual correction.

Model training program 110 adds the comparison of the records to the training data for the identified model (step 210). In an embodiment, model training program 110 adds the comparison data elements of the two record attributes to the model training database of model training database(s) 116 corresponding to the model of model(s) 114 that is associated with the common attribute. Since the data steward made the manual correction, the model associated with the common attribute was not predicting matches sufficiently. Adding the current comparison data as a training record is advantageous because it improves the probability that the model associated with the common attribute will perform better in the future. For example, if the common attribute is “name” and model 114₁ is associated with the attribute “name,” then model training program 110 adds the training data for model 114₁, i.e., training data for names, to model training database 116₁.

If model training program 110 determines the number of common attributes is greater than one (“yes” branch, decision block 206), then model training program 110 identifies the models for the common attributes (step 212). In an embodiment, model training program 110 determines the two data records have two or more attributes in common, therefore model training program 110 identifies a machine learning model, i.e., one of model(s) 114, associated with each of the common attributes. Continuing the example above, if record X includes a name, an address, and a social security number while record Y includes a name, an address, and a birthdate, then the common attributes are name and address, and model training program 110 identifies the attribute-specific model for name and the attribute-specific model for address. As discussed with respect to step 208, the identified models are responsible for not detecting the link/unlink performed by the data steward prior to the manual correction.

Model training program 110 retrieves weights associated with the common attributes (step 214). In an embodiment, since there is more than one common attribute, model training program 110 determines a probable weighting for the individual attributes by retrieving weights from customer weight database 120, which are the weights that matching engine 108 uses for attribute comparisons. The higher the weight, the higher the influence of the attribute on a matching decision. In an embodiment, model training program 110 requests the user provide the most important attributes for the decision in real time, via MDM user interface 124, in order to create more accurate weights.

Model training program 110 applies the weights to the attributes (step 216). In an embodiment, model training program 110 applies the retrieved weights to the corresponding attributes. Applying the weights is advantageous because the combination of the weight with the attribute indicates the significance of the attribute in the training data. Continuing the example from above, having identified the common attributes are name and address, model training program 110 applies weights retrieved from customer weight database 120 to the corresponding attributes in the comparison.

Model training program 110 adds the comparison of the weighted records to the training data of the identified models (step 218). In an embodiment, model training program 110 adds the comparison data elements of the two or more common attributes to the model training databases of model training database(s) 116 corresponding to the two or more models of model(s) 114 that are associated with the common attributes. As discussed with respect to step 210, adding the current comparison data as a training record is advantageous because it improves the probability that the models associated with the common attributes will perform better in the future. In an embodiment, model training program 110 may apply a threshold criterion to the weighted attributes. For example, record X and record Y both include name and address attributes, and the retrieved weights are 0.5 for name and 0.2 for address. Model training program 110 calculates a weighted probability as (0.5/(0.5+0.2)=71 percent, i.e., “name” contributes 71 percent to the matching decision. Model training program 110 also calculates a weighted probability as (0.2/(0.5+0.2)=29 percent, i.e., “address” contributes 29 percent to the matching decision. If the threshold is set to 30 percent, then model training program 110 adds the data for the attribute “name” to the corresponding model training database, but model training program 110 does not add, i.e., omits, the data for the attribute “address” because the contribution does not meet, i.e., is less than the threshold. Applying a threshold to the weighted attributes is advantageous because it fine tunes the adjustment of the training data to only include significant changes. In an embodiment, the customer provides the threshold, via MDM user interface 124. In an embodiment, the threshold is stored in customer weight database 120.

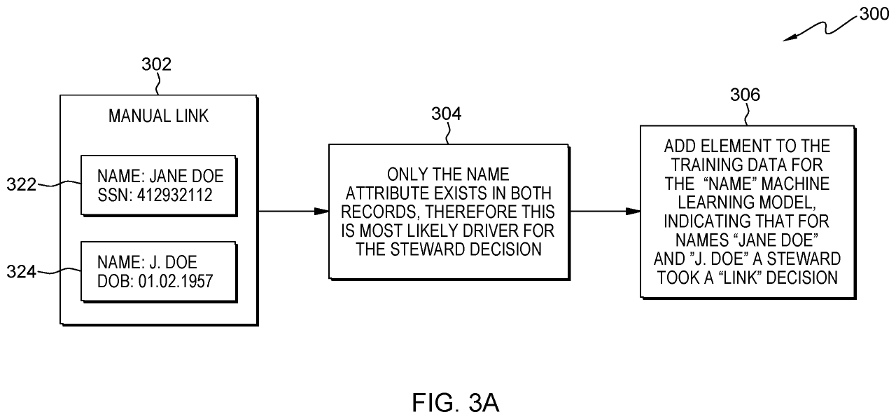

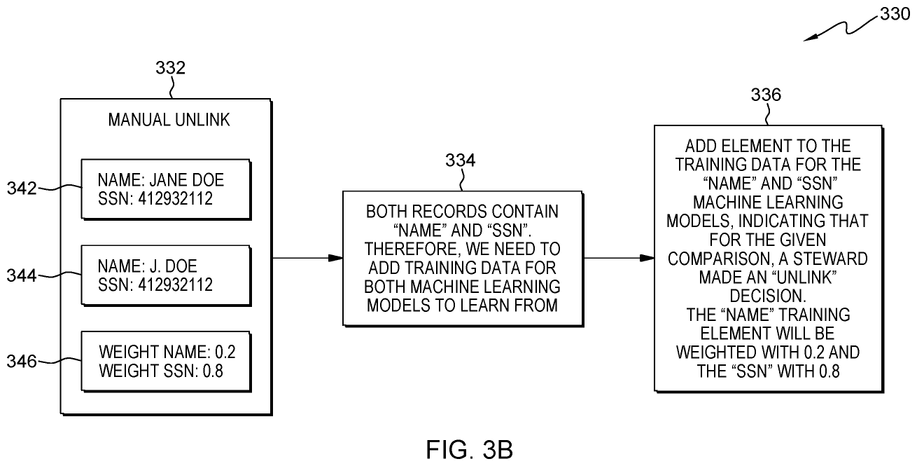

FIG. 3A illustrates example 300 of operational steps of model training program 110, on server computer 104 within distributed data processing environment 100 of FIG. 1, in accordance with an embodiment of the present invention. Example 300 includes box 302 which indicates the detection of a manual link by model training program 110. Box 302 includes data record 322 which includes the attributes “Name” and “SSN” (i.e., social security number) with the corresponding data elements “Jane Doe” and “412932112.” Box 302 also includes data record 324 which includes the attributes “Name” and “DOB” (i.e., date of birth) with the corresponding data elements “J. Doe” and “01.02.1957.”

Box 304 refers to step 204 of FIG. 2, where model training program 110 determines that data record 322 and data record 324 have one common attribute, “Name,” and therefore the name attribute is likely why the data steward made the manual link.

Box 306 refers to step 210 of FIG. 2, where model training program 110 adds the comparison of the data elements for “Name” to the model training database, thereby improving the training data for the machine learning model associated with the attribute “Name.”

FIG. 3B illustrates example 330 of operational steps of model training program 110, on server computer 104 within distributed data processing environment 100 of FIG. 1, in accordance with an embodiment of the present invention. Example 330 includes box 332 which indicates the detection of a manual unlink by model training program 110. Box 332 includes data record 342 which includes the attributes “Name” and “SSN” with the corresponding data elements “Jane Doe” and “412932112.” Box 332 also includes data record 344 which also includes the attributes “Name” and “SSN” with the corresponding data elements “J. Doe” and “412932112.” In addition, box 332 includes weights corresponding to the attributes “Name” (0.2) and “SSN” (0.8).

Box 334 refers to step 204 of FIG. 2, where model training program 110 determines that data record 322 and data record 324 have two common attributes, “Name” and “SSN,” and therefore new training data is needed for the machine learning models of both attributes.

Box 336 refers to steps 216 and 218 of FIG. 2, where model training program 110 applies weights corresponding to the attributes and adds the comparison of the weighted data elements for “Name” and “SSN” to the corresponding model training databases, thereby improving the training data for the machine learning models associated with the attributes “Name” and “SSN” with an indication of why the data steward made the unlink decision.

FIG. 4 depicts a block diagram of components of server computer 104 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 104 can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., model training program 110, model training database(s) 116, and customer weight database 120, are stored in persistent storage 408 for execution and/or access by one or more of the respective processor(s) 404 of server computer 104 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 122. In these examples, communications unit 410 includes one or more network interface cards. Communications unit 410 may provide communications through the use of either or both physical and wireless communications links. Model training program 110, model training database(s) 116, customer weight database 120, and other programs and data used for implementation of the present invention, may be downloaded to persistent storage 408 of server computer 104 through communications unit 410.

I/O interface(s) 412 allows for input and output of data with other devices that may be connected to server computer 104. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., model training program 110, model training database(s) 116, and customer weight database 120 on server computer 104, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
detecting, by one or more computer processors, a correction made to two data records;
determining, by one or more computer processors, a common attribute between the two data records;
identifying, by one or more computer processors, a first machine learning model associated with the common attribute; and
adding, by one or more computer processors, comparison data of the two data records to training data for the machine learning model, wherein the comparison data includes the correction.

2. The method of claim 1, further comprising:
determining, by one or more computer processors, two or more common attributes between the two data records;
identifying, by one or more computer processors, two or more machine learning models, each associated with one of the two or more common attributes;
retrieving, by one or more computer processors, a weight associated with each of the two or more common attributes;
applying, by one or more computer processors, the weight associated with each of the two or more common attributes corresponding to the two or more common attributes; and
adding, by one or more computer processors, a comparison data of the two data records to training data for the two or more machine learning models, each associated with one of the two or more common attributes, wherein the comparison data includes two or more weighted attributes.

3. The method of claim 2, further comprising:
determining, by one or more computer processors, a threshold for the weighted attributes;
calculating, by one or more computer processors, a weighted probability for each of the two or more common attributes;
determining, by one or more computer processors, at least one of the weighted probability for each of the two or more common attributes does not meet the threshold; and
omitting, by one or more computer processors, from training data for the machine learning model associated with the attribute whose weighted probability does not meet the threshold, the weighted probability.

4. The method of claim 2, further comprising receiving, by one or more computer processors, the weight associated with each of the two or more common attributes from a user.

5. The method of claim 1, wherein the correction is made by a data steward.

6. The method of claim 1, wherein the correction is selected from the group consisting of linking the two data records and unlinking the two data records.

7. The method of claim 1, further comprising, determining, by one or more computer processors, a number of common attributes between the two data records is greater than one.

8. A computer program product comprising:
one or more computer readable storage media and program instructions collectively stored on the one or more computer readable storage media, the stored program instructions comprising:
program instructions to detect a correction made to two data records;
program instructions to determine a common attribute between the two data records;
program instructions to identify a first machine learning model associated with the common attribute; and
program instructions to add comparison data of the two data records to training data for the machine learning model, wherein the comparison data includes the correction.

9. The computer program product of claim 8, the stored program instructions further comprising:
program instructions to determine two or more common attributes between the two data records;
program instructions to identify two or more machine learning models, each associated with one of the two or more common attributes;
program instructions to retrieve a weight associated with each of the two or more common attributes;
program instructions to apply the weight associated with each of the two or more common attributes corresponding to the two or more common attributes; and
program instructions to add a comparison data of the two data records to training data for the two or more machine learning models, each associated with one of the two or more common attributes, wherein the comparison data includes two or more weighted attributes.

10. The computer program product of claim 9, the stored program instructions further comprising:
program instructions to determine a threshold for the weighted attributes;
program instructions to calculate a weighted probability for each of the two or more common attributes;
program instructions to determine at least one of the weighted probability for each of the two or more common attributes does not meet the threshold; and
program instructions to omit from training data for the machine learning model associated with the attribute whose weighted probability does not meet the threshold, the weighted probability.

11. The computer program product of claim 9, the stored program instructions further comprising program instructions to receive the weight associated with each of the two or more common attributes from a user.

12. The computer program product of claim 8, wherein the correction is made by a data steward.

13. The computer program product of claim 8, wherein the correction is selected from the group consisting of linking the two data records and unlinking the two data records.

14. The computer program product of claim 8, the stored program instructions further comprising program instructions to determine a number of common attributes between the two data records is greater than one.

15. A computer system comprising:
one or more computer processors;
one or more computer readable storage media;
program instructions collectively stored on the one or more computer readable storage media for execution by at least one of the one or more computer processors, the stored program instructions comprising:
program instructions to detect a correction made to two data records;
program instructions to determine a common attribute between the two data records;
program instructions to identify a first machine learning model associated with the common attribute; and
program instructions to add comparison data of the two data records to training data for the machine learning model, wherein the comparison data includes the correction.

16. The computer system of claim 15, the stored program instructions further comprising:
program instructions to determine two or more common attributes between the two data records;
program instructions to identify two or more machine learning models, each associated with one of the two or more common attributes;
program instructions to retrieve a weight associated with each of the two or more common attributes;
program instructions to apply the weight associated with each of the two or more common attributes corresponding to the two or more common attributes; and
program instructions to add a comparison data of the two data records to training data for the two or more machine learning models, each associated with one of the two or more common attributes, wherein the comparison data includes two or more weighted attributes.

17. The computer system of claim 16, the stored program instructions further comprising:
program instructions to determine a threshold for the weighted attributes;
program instructions to calculate a weighted probability for each of the two or more common attributes;
program instructions to determine at least one of the weighted probability for each of the two or more common attributes does not meet the threshold; and
program instructions to omit from training data for the machine learning model associated with the attribute whose weighted probability does not meet the threshold, the weighted probability.

18. The computer system of claim 16, the stored program instructions further comprising program instructions to receive the weight associated with each of the two or more common attributes from a user.

19. The computer system of claim 15, wherein the correction is made by a data steward.

20. The computer system of claim 15, wherein the correction is selected from the group consisting of linking the two data records and unlinking the two data records.
